(19) United States
(12) Patent Application Publication
(10) Pub. No.: US 2014/0353231 A1
(43) Pub. Date: Dec. 4, 2014

(54) METHODS FOR FUNCTIONAL ENHANCEMENT OF CERAMIC MEMBRANES AND SYSTEMS FOR SEPARATION OF AQUEOUS MIXTURES

(71) Applicant: PURE VISIONS TECHNOLOGY, LLC, Grapevine, TX (US)

(72) Inventors: Eduardo Gomez Maqueo Arechiga, Monterrey (MX); Felipe Alberto Lembcke Barriga, Houston, TX (US)

(21) Appl. No.: 13/907,830

(22) Filed: May 31, 2013

Related U.S. Application Data
(60) Provisional application No. 61/812,278, filed on Apr. 16, 2013.

(51) Int. Cl. C02F 1/00

(52) U.S. Cl. CPC C02F 1/001
USPC 210/191; 210/510.1; 210/416.1; 210/196; 210/490; 427/230; 427/8

(57) ABSTRACT

The present application presents the development of a method for enhancing filtration capabilities of ceramic elements by chemically binding a hydrophilic compound throughout the porous structure of a ceramic element. An enhanced ceramic filter includes a ceramic element with chemically bound hydrophilic molecules. The enhanced ceramic filter is used in a system for the separation of non-polar compounds from aqueous mixtures. An aqueous mixture is passed through the enhanced ceramic filter, allowing water to permeate, and concentrate to exit the filter.

### BACKGROUND

1. Field of the Invention

The present application relates generally to filtration of aqueous mixtures, and more particularly to an improved ceramic filtration system and device.

2. Description of Related Art

A common problem for industries is the treatment of organic effluents mixed with water before disposal or sending them back to the environment. Such mixtures are usually hard to separate and a series of energy intensive processes or filtration devices are usually required to carry out an efficient separation. Current methods and systems for efficient separation of such mixtures suffer from reduced permeation flow rates, caused mainly by the need of using very small membrane pore sizes and from membrane fouling and blockage. This application addresses such problems.

Additionally, attempts have been made to bind particles to the surface of the membrane layers by thermal methods. However, even when including hydrophilic molecules, the surface of the membranes is susceptible to erosion leaving the filter compromised. Furthermore, particles bound to the surface layer of the membranes include more intricate manufacturing steps involving application and heat treatments to a substrate surface to reinforce the structure, which destroys some of the surface-enhancing chemicals used.

Although great strides have been made, considerable shortcomings remain.

### DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is an assortment of various styles of ceramic elements according to the preferred embodiment of the present application;

FIG. 2 is an enlarged view of a set of enhanced ceramic filters according to the preferred embodiment of the present application;

FIG. 3 is an enlarged view of the porous structure of the enhanced ceramic filters of FIG. 2 before and after reaction with a hydrophilic molecule;

FIG. 4 is a representation of pore-size reduction and a non-polar entropic barrier zone within the ceramic filters of FIG. 2;

FIG. 5 is method of making the ceramic filters of FIG. 2 from a ceramic element;

FIG. 6 is a chart of a system used to make the ceramic filters of FIG. 2; and

FIG. 7 is an enlarged view of a housing unit used in the system of FIG. 6 for housing ceramic elements for chemical binding of the hydrophilic molecule.

While the system and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE PREFERRED EMBODIMENT

While the system and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the device described herein may be oriented in any desired direction.

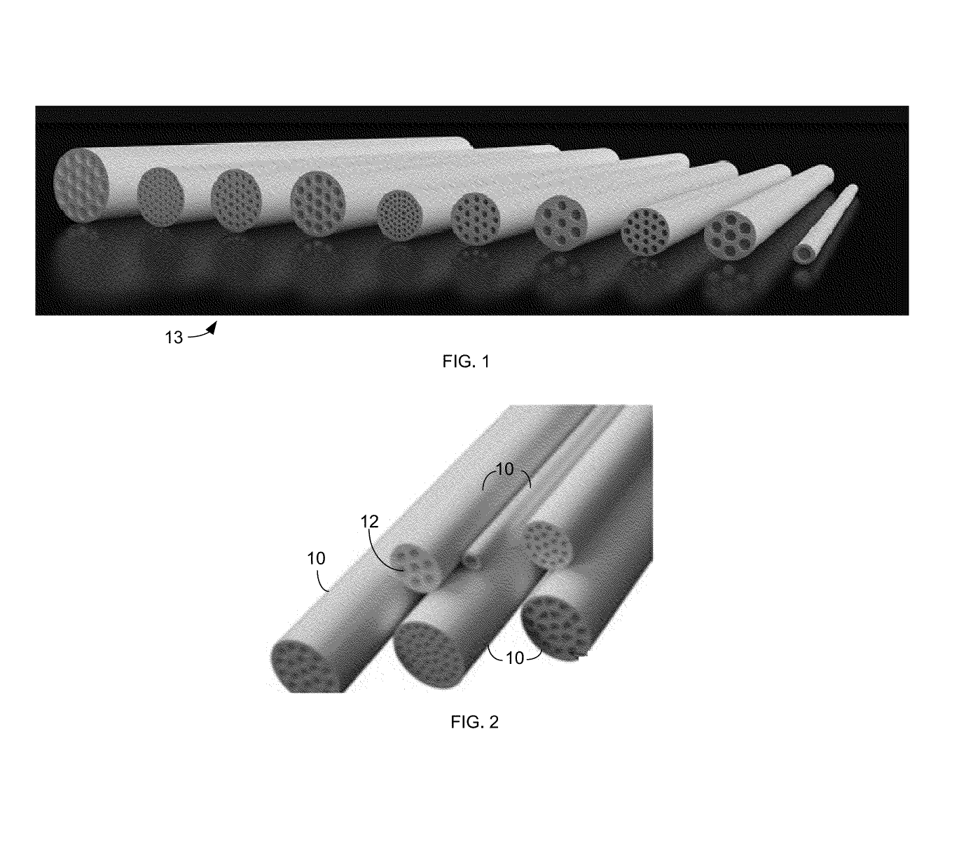

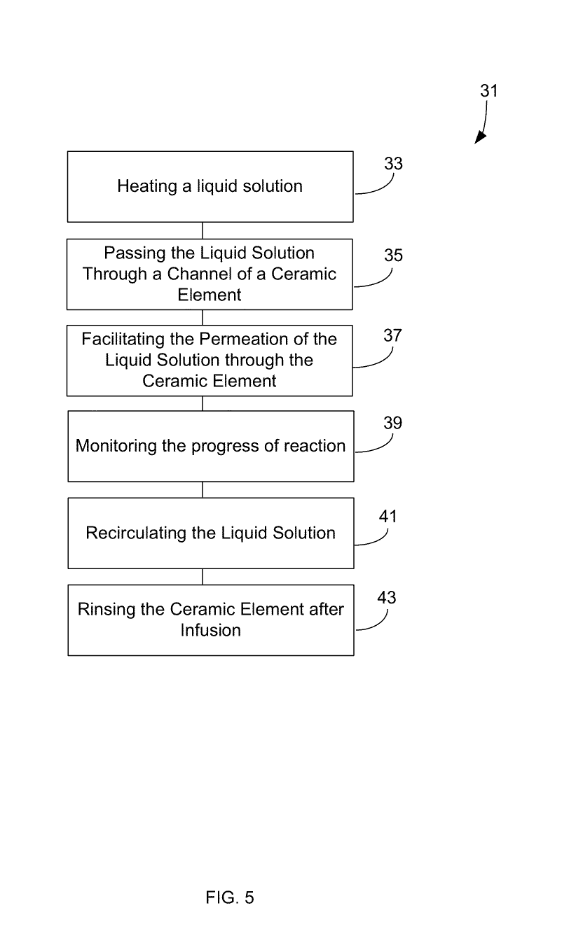

The present application presents the development of a new method for enhancing filtration capabilities of ceramic elements by forcing a solution of a hydrophilic compound throughout a portion of the porous structure of a ceramic element and chemically reacting the hydrophilic compound with the ceramic element to form an enhanced ceramic filter 10 (see FIG. 2). In the preferred embodiment, reaction and chemical binding of the hydrophilic compound occurs throughout the entire porous structure. An assortment of various styled ceramic elements 13 are depicted in FIG. 1. Additionally, the present application presents the development and design of a system using such enhanced ceramic filters 10 for separating organics from aqueous mixtures (see FIGS. 5-7).

The present invention provides the functionalization of ceramic filters 10 for the separation of non-polar compounds (like hydrocarbons) from aqueous mixtures (e.g. seawater, brines, process water). Such enhanced ceramic filters 10 generally comprise: (1) a ceramic element, with an specific pore size (for example: 30 nm, 50 nm, 100 nm, 200 nm, 500 nm, 0.14 μm, 0.2 μm, 0.45 μm) and a channel 12 number (for example: 1, 7, 9, 19, 37, 61 channels) and arrangement (for example: triangular, square pitch); and (2) a plurality of attached hydrophilic molecules 20 (for example: carboxylic acids, zwitterions) chemically bound throughout the ceramic element.

Additional aspects of the present application pertain to methods for separating non-polar compounds from an aqueous mixture. Such methods generally comprise: (1) providing the enhanced ceramic filter 10; and (2) flowing the aqueous mixture through the enhanced ceramic filter 10 to reject the non-polar compounds for flowing across the filter. In some embodiments, the ceramic filter 10 may have catalytic activity for the mineralization of carbon containing compounds present in the mixture.

Other embodiments of the present invention pertain to systems for separation of non-polar compounds from an aqueous mixture. Such systems generally comprise: (1) the above-described enhanced ceramic filter 10; and (2) a housing unit 55 housing the enhanced ceramic filter, that permeates water along with polar compounds out of the aqueous mixture in a cross-flow filtration configuration.

Additional embodiments of the present application pertain to methods of manufacturing the enhanced ceramic filters. Such methods generally comprise the reactive binding of hydrophilic molecules to a commercially available ceramic element or metallic oxide ceramic matrix (for example: Alumina, Magnesia, Titania or Zirconia based). No fusion, heat treatment or sintering is required to bind or fuse the hydrophilic molecules with the ceramic element as seen with surface layering of hydrophilic membranes.

As set forth in more detail below, the methods, filters and systems of the present application provide numerous improvements in separating non-polar compounds from aqueous mixtures, like oil-contaminated sea water, production water used in gas fracturing processes and industrial effluents, for example.

It is to be understood that both the foregoing general description and the following detailed description are exemplary and explanatory only, and are not restrictive of the invention, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements and components comprising one unit and elements and components that comprise more than one unit unless specifically stated otherwise.

### Enhanced Ceramic Filter

Referring to FIGS. 1-3 in the drawings, an enhanced ceramic filter 10 according to the present application is illustrated. Filter 10 is made up of a ceramic element 13 and hydrophilic molecules 20 (FIG. 4) chemically bound within the porous structure of element 13. Ceramic elements 13 are typically a porous structure of one or more materials, for example: Alumina, Magnesia, Titania or Zirconia based. In the preferred embodiment, filter 10 utilizes a ceramic element 13 of pure aluminum oxide. The ceramic element 13 is enhanced through the reactive binding of hydrophilic compounds/molecules throughout the entire porous structure of the ceramic element. This is different from the application of a membrane layer having hydrophilic properties. Membrane layers include attachments of additional particles over the exposed surface of a support element. The ceramic element acts as a structural support to the new layers of surface membrane. In the present application, ceramic filters 10 are configured to have hydrophilic compounds bonded through a filtration enhancement process, such that the hydrophilic properties are incorporated into the entire porous structure of the ceramic element. The hydrophilic molecules are bonded, absorbed, or attached through pores as liquid solution carrying the hydrophilic molecules is transported through the ceramic element 13.

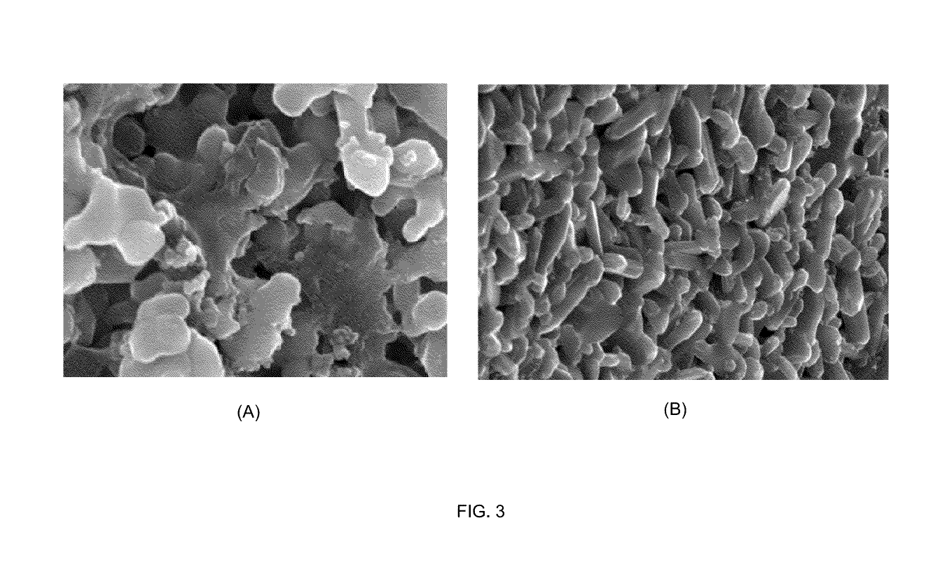

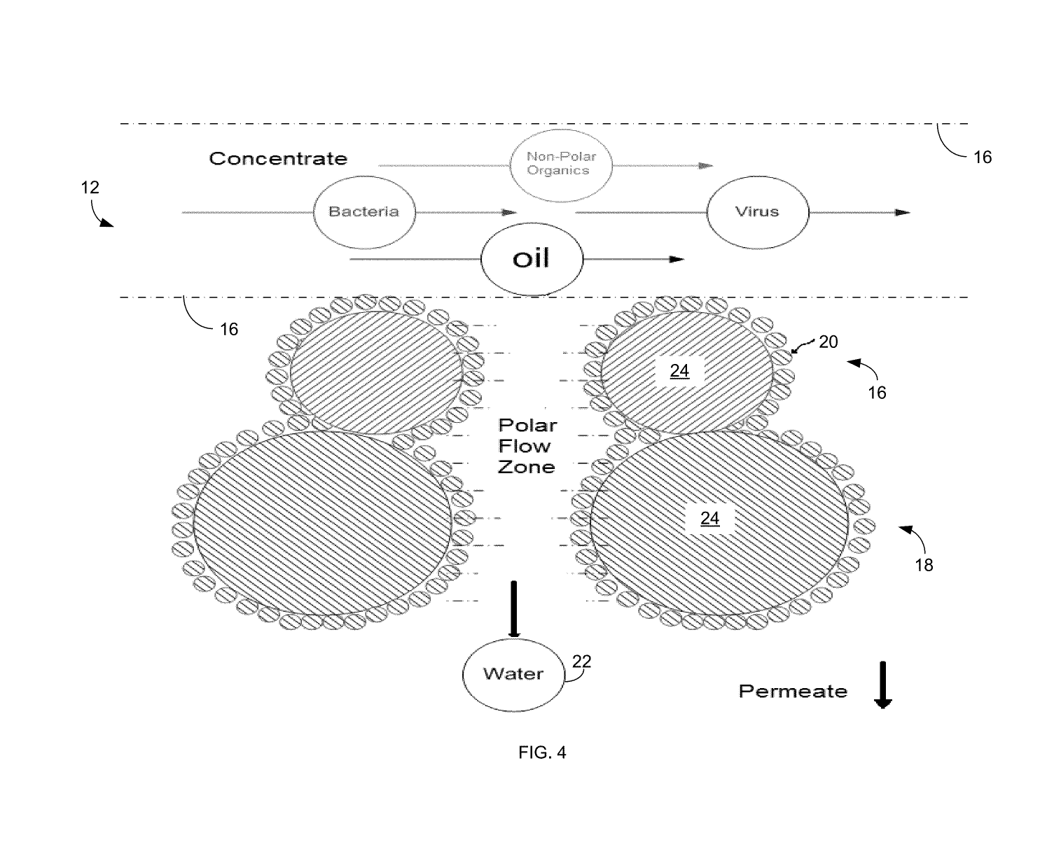

As seen in particular with FIG. 3 in the drawings, a ceramic element 13 is illustrated in (A) while an enhanced ceramic filter 10 with chemically bound hydrophilic molecules is illustrated in (B), as seen through a scanning electron microscope. Filter 10 is configured such that the porosity is unchanged as a result of the filtration enhancement process by the reactive binding of hydrophilic molecules.

In industrial processes, it is common to have organic material in aqueous solutions coming from process water, washing operations, cooling, etc. The concentration and toxicity of the materials define the proper treatment options before final disposal. Typical organic material includes, but is not restricted by, polymers used in electronic component manufacturing, oil-based material coming from gas fracturing processes or oil fields, automotive industry effluents, oily water from metal-forming and stamping operations, coolant mixtures used in machining operations, etc. In many cases, these organics in the aqueous solution mixture form emulsions which make the separation even more difficult.

In size exclusion filtration processes, the selection of the pore size within the filter is critical to being able to retain the organic material in the mixture, and permeating water. Proper operation and selection may reduce the degree of fouling and blockage of the pores, but adsorption of the organics to the pores ends up in a reduced lifespan. Membrane filtration processes have become a preferred method for large scale separation of oily wastewaters. However, due to their deficiencies noted previously, the filtration enhancement process of the present application improves performance without focusing on size exclusion as a dominant factor.

Filter 10 is configured to have one or more layers of varied porosity. In the preferred embodiment, each layer of porosity is of the same material. It is understood that other embodiments may use different materials for each layer. In the preferred embodiment, filter 10 uses a ceramic element 13 of aluminum oxide. Filter 10 may have a specific pore size of: 30 nm, 50 nm, 100 nm, 200 nm, 500 nm, 0.14 μm, 0.2 μm, or 0.45 μm, for example. Where multiple layers of varied porosity are used, a progressively decreasing porosity is used so as to have the smallest porosity exposed to the aqueous solution first. For example, some embodiments may use two layers: a first layer of 5.0 μm and a second layer (internal) of 0.2 μm. However, filter 10 is not so limited and may arrange the pore sizes in any manner.

In the preferred embodiment, filter 10 has a pore size at least 0.2 μm. This size restriction is to satisfy governmental standards on filtration that state filters must have pore sizes of 0.2 μm or smaller to ensure the aqueous solution is free from bacteria. In the preferred embodiment, filter 10 has pore sizes of at least 0.2 μm to meet the requirements of governmental standards. In other embodiments, Filter 10, having chemically bound hydrophilic properties throughout its entire structure, is able to use larger pore sizes and still maintain bacteria free liquid. The reactive binding of hydrophilic molecules throughout ceramic element 13 permit filter 10 to use pore sizes larger than 0.2 μm and adequately filter an aqueous solution mixture to produce bacteria free water in compliance with governmental standards. The chemically bound hydrophilic molecules throughout the ceramic structure of filter 10, filters non-polar molecules.

Filter 10 includes one or more channels 12 as seen in FIGS. 1 and 2. For example, filter 10 may include: 1, 7, 9, 19, 37, or 61 channels 12. An aqueous solution to be filtered passes within channels 12 and permeates through the structure of filter 10 in a cross flow filtration process. Since the aqueous solution flows tangentially at a set velocity through channel 12 during operation, a strong bond between the deposited hydrophilic compound and the ceramic element is required to withstand the possible erosion of the surface. This erosion is characteristically a potential flaw in using layers of particles thermally bound to a membrane on the surface as opposed to the filtration enhancement process of reacting the hydrophilic molecules and chemically binding them throughout ceramic element 13 to form filter 10. Channels 12 may be arranged in multiple patterns and shapes. For example: triangular, square pitch. It is understood that filter 10 is called out in numerous locations in FIG. 2, each having a different channel pattern. Filter 10 is not limited to any specific channel pattern and the multiple callouts are illustrative of multiple possible channel pattern embodiments.

Referring now also to FIG. 4 in the drawings, a representation of pore-size reduction and non-polar entropic barrier zone is illustrated. By reacting hydrophilic molecules (for example: carboxylic acids, zwitterions) within ceramic element 13, the arrangement of the molecules from the aqueous mixture close to the surface of filter 10 become predisposed to attract water and repel organics. Many hydrophilic substances of diverse nature may be used to enhance the properties of filter 10. By definition, hydrophilic means water loving. A hydrophilic compound has an affinity to water and is usually charged or has polar side groups to its structure that will attract water. Barite, hematite, minerals in drilling fluids, glucose, sugar and many other substances are known as hydrophilic. In comparison, oils, proteins, colloids, greases and clays are hydrophobic.

Having chemically bound hydrophilic molecules throughout ceramic element 13, a series of layers of water molecules are formed throughout the porous structure of filter 10, greatly increasing the prevention of organics close the surface of filter 10 and becoming adsorbed into filter 10. The multiple water layers throughout filter 10 help prevent the fouling of the pores in filter 10. Once being attracted by the hydrophilic molecules, water can flow through the pores, pushed by a pressure difference between the concentrate and permeate sides. Multiple layers of water molecules throughout the structure of filter 10 also permit filter 10 to utilize pore sizes larger than 0.2 μm and still maintain adequate bacteria filtration.

Fortunately, chemically reacting hydrophilic molecules through the entire aluminum oxide material, as proposed in the present application, allows using a larger pore size than used in conventional ceramic membrane operations. Some advantages of having layers of water molecules throughout the ceramic structure of filter 10 is: reduced operational costs (reduced pressure, slower tangential speed) and reduced fixed costs (Longer filter lifetime). It can be said that the ionic nature of the newly attached molecules have a steric effect on the pore structure, reducing the size of the molecules which can go thru them.

The functionalization of an Alumina matrix (i.e. element 13) with a carboxylic acid (i.e. hydrophilic molecule) occurs at an appropriate temperature and can change the structure of ceramic element 13. The carboxylic acid reacts with the exposed surfaces of the ceramic element, throughout every pore. There is no sintering or heat treatment required to bind the carboxylic acid to the ceramic element after the reaction step, compared to other methods.

Examples of Carboxylic acids are Acetic acid, Maleic acid, Malonic acid, Fumaric acid, Octanoic acid, 2-amino 3-phosphonopropanoic acid, 2-amino 3-sulfopropanoic acid among others. The molecule to be bound to ceramic element 13 is such that provides a hydrophilic nature throughout filter 10. In this case, the radical to be used is selected among a series of Zwitterion acids. In chemistry, a zwitterion is a neutral molecule with a positive and a negative electrical charge at different locations within that molecule. Amino acids are the best-known examples of zwitterions. These compounds contain an ammonium and a carboxylate group, and can be viewed as arising via a kind of intra-molecular acid-base reaction.

In the preferred embodiment, one of two effective acids is used, namely: 2-amino 3-sulfo propanoic acid and 2-amino 3-phosphono propanoic acid. Both retain their zwitterion characteristic upon being bound to the ceramic element. The amino group gets protonated and the sulfo or phosphono group becomes negative. This allows an ordering or selective deposition of the carboxylic acid over the structure of ceramic element 13, having strong hydrogen bonding among adjacent radicals, creating a suitable environment for water molecules to be attracted to. Water molecules align themselves according to the ionic charges of filter 10 and move closer to the surface, thus facilitating the passing of water molecules, as forced by the pressure difference between the aqueous mixture internal to filter 10 and a permeate side external to filter 10. Effectively, a pore-size reduction occurs due to the incorporation of the zwitterion to the ceramic element and an entropic barrier for non-polar compounds is created by their ionic structure. This entropic zone attracts polar compounds and rejects non-polar compounds. It should be noted ionic molecules, polar molecules and hydrophilic molecules are attracted also to the porous surfaces of filter 10 and are most likely to follow water, provided the size of each allows them to pass the pores.

As seen in particular to FIG. 4, surface 14 of channel 12 is illustrated to assist in the visualization of channel 12 within filter 10. FIG. 4 provides an enlarged view of the porous structure of filter 10. A pore-size reduction within filter 10 is illustrated in the size difference between a first outer layer 18 and a second internal layer 16. A zwitterion 20 is seen chemically bound to the surface of the aluminum oxide ceramic element 24 (compare also to ceramic element 13). As illustrated in FIG. 4, the reaction of hydrophilic molecules occurs throughout the entire structure of filter 10 and is not an applied layer, or added membrane layer to the surface only. Aqueous liquid travels through channel 12. Contaminants or organics are repelled by zwitterions 20 thus permitting for the passage of water 22 to permeate through filter 10.

It is understood that although filter 10 has been described as having hydrophilic molecules chemically bound throughout the entire ceramic element 13, binding of hydrophilic molecules may be selectively applied through portions of ceramic element 13, such that less than the full ceramic element 13 has been exposed to the chemical solution and when the reaction step occurs, only the wetted surface reacts with the hydrophilic molecule.

### System and Method of Making and Using the Enhanced Ceramic Filter

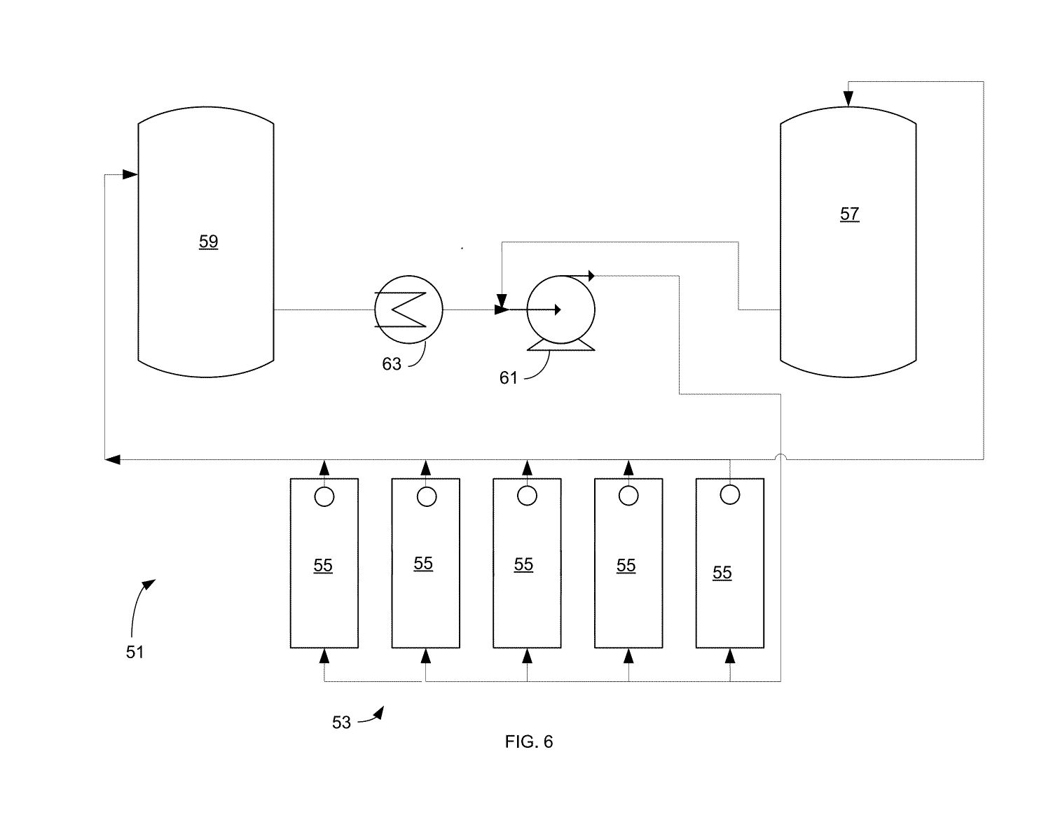

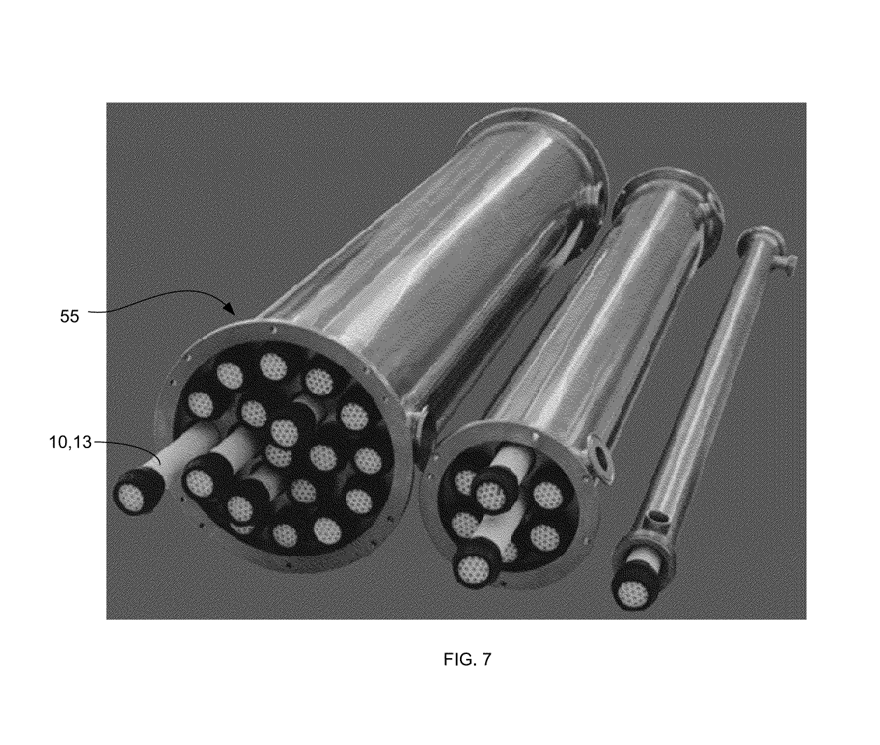

Referring now also to FIGS. 5-7 in the drawings, the machinery and process for making enhanced ceramic filter 10 is illustrated. Ceramic elements 13 are functionalized with hydrophilic molecules 20 (i.e. zwitterions) within a system 51 (see FIG. 6). To do so, system 51 utilizes a reactor vessel 53 which includes one or more housing units 55. One or more ceramic elements 13 are arranged inside each housing unit 55. Housing units 55 may accommodate any number of ceramic elements 13 depending on the overall surface area required. As seen in FIG. 7, unit 55 may include any number of ceramic elements 13. As such, housing unit 55 is selectively sized according to the number of ceramic elements 13 being housed. In this embodiment, system 51 utilizes five housing units 55.

System 51 includes a water holding tank 57 and a reacting liquid solution holding tank 59. Each tank 57 and 59 consist of a separate loop used to feed liquid through reactor 53. Holding tank 57 holds a liquid of deionized water used to pass through reactor 53, while holding tank 59 holds a liquid of reacting liquid solution being a combination of reacting zwitterion carboxylic acid mixed with water. As either liquid is passed through reactor 53, unit 55 is configured to route that liquid through the channels 12 of each ceramic element 13. The liquid from either tank 57 and 59 may either permeate through element 13 (called permeate) and/or may pass completely through housing unit 55 (called concentrate) and return back to the tank from which the liquid originated. Both permeate and concentrate flows are sent back to the holding tank 57 and 59 in that particular loop. Housing unit 55 is configured to collect any permeated liquid in a permeate side within housing unit 55. Permeate side is a volume external to elements 13 and internal to the walls of housing units 55.

System 51 operates first by inserting element 13 within housing units 55. Secondly, deionized water in tank 57 is passed through system 51 to clean elements 13 from any possible contaminant carried in from transport, and to prime the ceramic elements 13 by utilizing sufficient pressure to permeate the water into all the pores. Both flows exiting the housing are recirculated back at tank 57. The priming of element 13 displaces trapped air under pressure.

After priming, the reacting liquid solution from tank 59 is pumped through the internal channels 12 of ceramic elements 13, via a pump. Pump 61 may be used to pump liquid from either tank 57 or 59 through reactor 53. In one embodiment, a single pump 61 may be used to pump both liquids in tanks 57 and 59. In another embodiment, separate pumps 61 are used, each in communication with a single individual tank 57 or 59.

System 51 passes the reacting liquid solution through channels 12 at a higher temperature and with enough pressure to permeate the solution through a portion of the pores of the ceramic elements 13. The reacting liquid solution is heated in a heat exchanger 63 to an elevated temperature prior to being pumped through channels 12. In one embodiment, the reacting liquid solution is heated to a temperature below the boiling point of water. The exact temperature is partly dependent on technical and chemical considerations. In the preferred embodiment, permeation occurs through all the pores of ceramic elements 13 to obtain a complete coverage through the porous structure of element 13.

System 51 generates a continuous flow of liquid solution through reactor 53. The liquid within the open channels 12 travel at speeds in the range of 1-5 ft/s. Other speeds are considered feasible in other embodiments.

In order to facilitate permeation, system 51 generates a pressure differential between the interior of channel 12 (internal side) and the permeate side within housing 55. As a result of the pressure differential, some of the compounds/molecules from the reacting liquid solution which are small enough to go through the pores of ceramic element 13 are forced to permeate and get collected on the shell of the housing (called permeate), whereas the remainder of the reacting liquid solution (called concentrate) exits reactor 53 and is sent back to a holding tank 59 for recirculation 41. As the reacting liquid solution permeates through the porous structure of element 13, the reacting zwitterion carboxylic acid of the reacting liquid solution chemically reacts with the aluminum oxide element 13, thereby chemically binding the acid to element 13. By reacting the zwitterions carboxylic acid with ceramic element 13, the acidic concentration of the permeate is decreased. In the preferred embodiment, the permeate is also recirculated back into tank 59. The recirculation of the permeate with that of the concentrate in tank 59 slowly dilutes the concentration of the reacting liquid solution.

The amount of liquid permeated depends on the specific permeability of element 13, the overall surface area of the collection of channels 12, and the pressure difference between the internal side and the permeate side. Due to friction, there is a pressure drop between the entrance of the unit and the exit.

The degree of pore penetration and reaction for the hydrophilic component solution into the ceramic element 13 is controlled using the specific permeability of the ceramic element 13, trans-membrane pressure difference, temperature and reaction time.

Pump 61 associate with tank 59 functions to circulate fresh reacting liquid solution through each housing unit 55 during a reaction period. When a total desired reaction conversion is reached, reacting liquid solution ceases to circulate through units 55. After this end-point has been reached, the reactor 53 is drained into a rinse tank. A rinse pump is then used to transfer the waste solution to a waste storage tank (which is hard-piped in to the system). Fresh deionized water is then introduced to the rinse tank, which then serves to circulate the fresh water over filter 10, rinsing 43 any excess chemical that may be left behind.

Reactor 53 is equipped with a number of sensors (Conductivity, total dissolved solids (TDS), temperature, pH, flow-rate, pressure) to facilitate the data acquisition process and to determine when the reaction is completed. pH meters are positioned on the outlet side of each pump. Sensors for solution conductivity (or TDS), flow rate, and temperature are strategically placed throughout reactor 53. Reaction progress as a function of either conductivity or total dissolved solids (TDS), in addition to other relevant reaction conditions (i.e., temperature, pH, and flow rates) are centrally monitored.

Reaction progress is monitored 39 individually for each housing unit 55 full of elements 13 to identify performance issues which may occur based on distance from the pump. Solution conductivity (or TDS) is used as indicator of reaction progress, thereby allowing plotted curves representing the extent of reaction to be plotted as a function of reaction time. These curves serve as a means of identifying the reaction end-point.

Typically, the reaction end-point is assumed to have been reached when the curves level off for two or three data points. Temperatures to carry out the reaction can be in the range of 60 to 205° F. and are dependent on the zwitterion used. Typical reaction times can range from 6 hours to 48 hours based on zwitterion used, reactive mixture concentration, and temperature of the batch.

It is important to note that reactor 53 is used in the process or system to both enhance the ceramic membrane filtering capabilities by chemically reacting a zwitterion as described above and in using the enhanced ceramic membranes as a filter 10 to separate organic compounds from a liquid. By coupling reactor 53 to liquid solutions to be filtered, the process of system 51 may be used to function as a filter. During use as a filtering system, system 51 is configured to restrict the recirculation of permeated liquid from that of concentrate liquid.

Turning now also to the method illustrated in FIG. 5. Filter 10 is configured to separate organic compounds from a liquid solution. As seen in FIG. 5, the method 31 of making filter 10 includes heating 33 a liquid solution of hydrophilic molecules and water; sending 35 the liquid solution through channels within a porous ceramic element; and facilitating 37 the permeation of the liquid solution through the pores of the ceramic element, such that the dissolved hydrophilic molecules infuse and react with a portion of the ceramic element. Together, ceramic element 13 and the chemically bound hydrophilic molecules 20 form the enhanced ceramic filter 10.

Reaction progress is monitored 39 to identify the reaction end-point. The end-point is reached when the amount of the hydrophilic molecules chemically bound to element 13 reaches the desired conversion. Rinsing 43 is performed after the end-point is attained.

In review, the enhanced ceramic filter 10 of the present application can be used to separate various (non-polar) organic compounds from aqueous mixtures. For instance, in some embodiments, organic compounds to be separated are hydrocarbons, such as those present in crude oil, coming for hydraulic fracturing operations or oil fields. In other embodiments, these systems may be used to aid other processes by pre-treating an aqueous mixture to remove (non-polar) organic compounds and/or biological matter which may foul the downstream processing units. Other embodiments of the present invention include the separation of polymers from water, like those used in electronics manufacturing processes or oils used in the machining processes.

Complete coverage of the exposed internal surface of ceramic element 13, including the pores, provides a reduction of the available flow area in the pores for compounds to flow and also creates an entropic barrier for non-polar components to travel through them. Also, this zone attracts polar components, making it easier for them to flow through.

Economic advantages for using this enhanced ceramic filter include the reduced pressure required to obtain a certain flux due to the enhanced permeability of the filter, the requirement of lower tangential speeds due to the water layer formation on the layers of the filter 10 and the sustenance of the flux across time by not getting blocked or fouled. Also, by using larger ceramic pore sizes, the capital cost is reduced since ceramic membrane cost is inversely proportional to the pore size.

An enhanced hydrophilic ceramic filter is capable of screening non-polar compounds from non-polar/water emulsions. The above results are due to the functionalized ceramic surfaces, and the zwitterion acid molecules that allow water molecules and polar molecules to align using hydrogen bonding. This interaction allows formation of an aqueous layer on the surfaces of the ceramic filter, which helps prevent fouling and more importantly provides an entropic barrier for which the non-polar components contained within the aqueous mixtures studied cannot cross.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. A ceramic filter for separating organic compounds from a liquid, comprising:
a ceramic element having a porous structure and one or more channels for the transportation of the liquid; and
a plurality of hydrophilic molecules chemically bound into the porous structure of the ceramic element;
wherein the chemically bound hydrophilic molecules within the ceramic element are configured to separate organic compounds from the liquid independent of the size of pores in the porous structure.

2. The ceramic filter of claim 1, wherein the ceramic element is aluminum oxide.

3. The ceramic filter of claim 1, wherein the ceramic element has multiple layers, each layer having a separate pore size.

4. The ceramic filter of claim 3, wherein each layer has a pore size of at least 0.2 microns.

5. The ceramic filter of claim 1, wherein the hydrophilic molecules in the ceramic element are from the group consisting of Acetic acid, Maleic acid, Malonic acid, Fumaric acid, Octanoic acid, 2-amino 3-phosphonopropanoic acid, and 2-amino 3-sulfopropanoic acid.

6. The ceramic filter of claim 1, wherein the ceramic element is a metallic oxide ceramic matrix.

7. The ceramic filter of claim 1, wherein non-polar molecules are prevented from passing through the porous structure.

8. The ceramic filter of claim 1, wherein hydrophilic molecules are chemically bound throughout the entire porous structure of the ceramic element.

9. A method of making an enhanced ceramic filter for separating organic compounds from a liquid, comprising:
heating a liquid solution of hydrophilic molecules dissolved and water;
passing the liquid solution through channels within a porous ceramic element; and
facilitating the passing of the liquid solution through the pores of the ceramic element, such that the dissolved hydrophilic molecules react with and are chemically bond to a portion of the ceramic element;
wherein the ceramic element and the chemically bound hydrophilic molecules form the enhanced ceramic filter.

10. The method of claim 9, wherein the aqueous mixture is heated below the boiling point of water.

11. The method of claim 9, further comprising:
priming the ceramic elements with water.

12. The method of claim 9, wherein the hydrophilic molecules are at least one of Acetic acid, Maleic acid, Malonic acid, Fumaric acid, Octanoic acid, 2-amino 3-phosphonopropanoic acid, and 2-amino 3-sulfopropanoic acid.

13. The method of claim 9, wherein the hydrophilic molecules are chemically bound throughout the entire structure of the ceramic element.

14. The method of claim 9, further comprising:
monitoring at least one of the ph-balance of the liquid solution and the conductivity of the liquid solution to detect the progress of reaction between the hydrophilic molecules and the ceramic element.

15. The method of claim 9, further comprising:
continuously recirculating the liquid solution through the pores of the ceramic element until the desired reaction conversion is obtained.

16. The method of claim 9, further comprising:
rinsing the ceramic element when the reaction step is completed.

17. A system for separating organic compounds from a liquid, comprising:
A first tank for holding a liquid containing a hydrophilic compound;
a housing unit for securing a porous ceramic element; and
a pump in communication with the tank for circulating the liquid through the ceramic element in the housing unit;
wherein the hydrophilic compound is chemically bound with the porous ceramic element during permeation through the pores of the ceramic element.

18. The system of claim 17, further comprising:
A second tank configured to store a liquid to pass through the ceramic element to at least one of the following clean the ceramic element and rinse the ceramic element.

19. The system of claim 17, wherein permeate fluid and concentrate liquid from the first tank is configured to recirculate.

20. The system of claim 17, wherein the chemical binding of hydrophilic compounds is configured to form water layers throughout the ceramic element, such that organic compounds are separated from the water.
